(19) United States
(12) Patent Application Publication
(10) Pub. No.: US 2006/0198930 A1
(43) Pub. Date: Sep. 7, 2006

(54) Center-filled jelly confections

(75) Inventors: Angel Palomes Royo, Barcelona (ES); Albert Xambo Garcia, Savadell (ES); Ignasi Cugat Fiter, El Masnou (ES)

Correspondence Address: WRIGLEY & DREYFUS 28455;BRINKS HOFER GILSON & LIONE, P.O. BOX 10395, CHICAGO, IL, 60610, US

(73) Assignee: Wm. Wrigley Jr. Company

(21) Appl. No.: 11/367,874

(22) Filed: Mar. 3, 2006

Related U.S. Application Data
(60) Provisional application No. 60/658,840, filed on Mar. 4, 2005.

(51) Int. Cl. A21D 13/00

(52) U.S. Cl. 426/94

(57) ABSTRACT

A center-filled jelly product is made with (a) a liquid filling containing between about 0.5% and about 5% flavor and (b) jelly material completely encasing the liquid filling, the jelly material comprising between about 9% and about 19% gelling agent. The liquid center filling provides the product with a strong initial flavor impact when bitten into. In an embodiment, the outer jelly material is transparent, and maintains a well-defined boundary with the liquid center filling. The outer jelly material provides a chewy texture to the product. The product is made by (a) making an outer jelly confection by (i) dissolving a gelling agent in water to form a gelling solution; (ii) heating a syrup containing a bulk sweetener to form a first mass; and (iii) mixing the first mass, the gelling solution and optionally one or more secondary ingredients to form a second mass; (b) making a liquid filling by mixing a thickening agent, one or more bulk sweeteners, water and flavor to form a liquid filling; and (c) depositing the second mass at a temperature of between about 60° C. and about 85° C., and the liquid filling at a temperature of between about 50° C. and about 85° C., into a mold such that the liquid filling is totally encased by the second mass and the second mass will fill into at least a portion of the shape of the mold.

### RELATED APPLICATION

The present application claims the benefit under 35 U.S.C. § 119(e) of Provisional U.S. Patent Application Ser. No. 60/658,840, filed Mar. 4, 2005; which is hereby incorporated by reference in its entirety.

### BACKGROUND OF THE INVENTION

The present invention relates to center-filled confectionery products, and more particularly to a jelly confectionery with a liquid center filling that may provide a high initial flavor impact, and methods of making such products.

There are many liquid filled confectionery products known in the art. Liquid center candies, as such, are favorites of many candy lovers. They provide a variety of textures and a level of interest not realized by many other candies, and provide a unique and recognizable point of difference to consumers. They are often produced with the same flavor in the filling as in the exterior, and sometimes with a complimentary, different flavor. Among the various types of liquid center candy products are jelly candies, chocolate creams, and the like. Sometimes, the center is not liquid when the product is made, but is liquefied later.

Presently, various procedures are used to manufacture liquid-center candies; such as fondant/invertase liquefaction, center-fill co-extrusion, injection filling and center-in-shell co-depositing. Fondant/invertase liquefaction is generally accomplished by mixing the enzyme, invertase, in a fondant that is enrobed with chocolate. The enzyme later converts the fondant to a liquid by breaking down sucrose to invert sugar. The enzymatic action is dependant on the amount of available moisture, pH, and temperature. This method does not work well with jelly candy because of the jelly candy's low moisture content. Jelly candy is put into molds at about 25-30% moisture and then cured for further drying. Thus, by the time the invertase has time to liquefy, the center filling, there is not enough water remaining for invertase action.

Center-fill co-extrusion is generally used to fill hard candy with jam-like material. The first step is to form a rope of hard candy. Second, a small pipe that sticks into the hard candy is used to pump jam into the candy. The rope of candy is then run through cutters, and pinched to form seams. This method is specific for hard candy, taffy or other high-cooked candy. However, center-fill co-extrusion does not work with jelly candy, because there are problems with seal failure. Center shell depositing uses a depositing nozzle that has a concentric design so that it can pump an outer stream and a center stream at the same time. Pumping is timed so that the outer shell is pumped into the mold first, and then the inside stream comes on after a sleeve of outer candy is created with the initial deposit. It is successfully used to fill peanut butter, fondant and other paste like fillings into chocolate. However, filling thin liquid into jelly candy has not been well demonstrated by this method due to excessive leaks. Leaks are more likely to develop with jelly candy than with other types of candy for several reasons. First, because of the density of sugary liquids, they will sink through hot jelly to the bottom of the mold. As a result, leaks will develop, because the bottom of the piece of candy will have a thin wall. Second, if pump timing is even slightly irregular, filling will be slightly to the side. This will create a thin outer wall, which creates potential for a leak. If the cut-off on the nozzle is not perfectly timed and a string of the inner liquid comes up through the outer jelly, a leak pathway will develop. Third, jelly candies tend to shrink and contract as they are dried. This gives them a pressurized effect. If there is any leak pathway within jelly candy, the liquid is squeezed out of the center.

Since flavors are better perceived in liquid than in colloidal jelly, a free flowing liquid center offers uniquely pleasant eating qualities and delivers a pronounced flavor advantage over solid jelly candy. Texture and eating qualities are improved by the liquid lubrication of the jelly mass during mastication. Since liquid centers are desirable, and present methods for preparing liquid-centered jelly candy are inadequate, a demand exists for a process to prepare a variety of center-filled candies.

It would be desirable if a product could be made that had a jelly (chewy) texture, but also included a liquid filling. It would be even more desirable if the product could provide a high initial flavor impact, such as a sudden menthol flavor burst, but then still be retained in the mouth with a duration of flavor as the product is masticated. It would further be desirable if the outer layer were transparent so that the liquid center were visible to the consumer before biting into the product, and that the liquid center maintained a well-defined boundary with the chewy outer layer.

### BRIEF SUMMARY OF THE INVENTION

A novel, center-filled confectionery product has been invented. In one embodiment the product provides a high initial flavor impact. Further, a method of making the product has also been invented. In an embodiment the product is sugarfree.

In a first aspect, the invention is a center-filled jelly product comprising: (a) a liquid filling containing between about 0.5% and about 5% menthol and a level of flavor in addition to the menthol of between about 0.3% and about 3.5% to provide the product with a strong initial flavor impact when bitten into; and (b) jelly material completely encasing the liquid filling, the jelly material comprising between about 9% and about 19% gelling agent and providing a chewy texture to the product.

In a second aspect, the invention is a center-filled jelly product comprising: (a) a liquid filling containing between about 0.5% and about 5% flavor to provide the product with a strong initial flavor impact when bitten into and about 0.05% and about 0.3% xanthan gum as a thickening agent; and (b) jelly material completely encasing the liquid filling, the jelly material comprising between about 9% and about 19% gelatin and providing a chewy texture to the product.

In a third aspect, the invention is a center-filled jelly product comprising: (a) a liquid filling containing between about 0.5% and about 5% flavor to provide the product with a strong initial flavor impact when bitten into and a coloring; and (b) jelly material completely encasing the liquid filling, the jelly material being transparent and comprising between about 9% and about 19% gelling agent and providing a chewy texture to the product.

In a fourth aspect, the invention is a method of making a center-filled jelly product comprising: (a) making an outer jelly confection by: (i) dissolving a gelling agent in water to form a gelling solution; (ii) heating a syrup containing a bulk sweetener to remove moisture and thereby form a first mass; and (iii) mixing the first mass, the gelling solution and optionally one or more secondary ingredients to form a second mass; (b) making a liquid filling by mixing a thickening agent, one or more bulk sweeteners, water and flavor to form a liquid filling; and (c) depositing the second mass at a temperature of between about 60° C. and about 85° C., and the liquid filling at a temperature of between about 50° C. and about 85° C., into a mold such that the liquid filling is totally encased by the second mass and the second mass will fill into at least a portion of the shape of the mold.

In some embodiments of the invention, the outer jelly layer is transparent and clear, and the liquid filling is colored, such that the liquid filling is visible to the consumer before the product is placed in the mouth. A quick flavor release is achieved as the liquid filling enters the mouth when the product is bitten into. If a high level of menthol and flavor are included in the center filling, a quick burst of menthol and flavor is achieved.

These and other advantages of the invention will be best understood in view of the attached drawings.

### BRIEF DESCRIPTION OF DRAWINGS

FIG. 1 is a flow chart showing a first method of the present invention.

FIG. 2 is a flow chart showing a second method of the present invention.

FIG. 3 is a depiction of a center-filled jelly product of the present invention.

FIG. 4 is a depiction of a first step in depositing the product of FIG. 3.

FIG. 5 is a depiction of a second step in depositing the product of FIG. 3.

FIG. 6 is a depiction of a third step, near the completion of the deposition of the product of FIG. 3.

### DETAILED DESCRIPTION OF THE DRAWINGS AND PREFERRED EMBODIMENTS

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

A center-filled jelly product 10 of the present invention is shown in FIG. 3. While the product of the present invention can be formed in any desired shape, the product 10 has swirled contours molded on its outer surface. It has an outer jelly material 12 and a liquid filling 14. The jelly material completely encases the liquid filling. As a general matter, the jelly material 12 comprises a gelling agent and provides a chewy texture to the product. On the other hand, the liquid filling 14 contains a high level of flavor. In the exemplary product 10 the jelly material is transparent and uncolored, and the liquid filling 14 is colored and visible through the jelly material 12. Also, in the product 10 the liquid filling and encasing jelly material have a distinct boundary between them (best seen in FIG. 6).

The jelly material 12 is made with one or more bulk sweeteners and a gelling material, and optionally other ingredients such as a food grade acid, a high-intensity sweetener and flavor. The liquid center is made from a thickening agent, one or more bulk sweeteners, water and flavor, and optionally other ingredients, such as a food grade acid and a high-intensity sweetener. When high levels of menthol are used, the liquid filling may also include a bitterness reducer. A bitterness reducer may comprise a high-intensity sweetener, particularly neohespridine.

The bulk sweeteners that may be used in the jelly material and in the liquid filling may be sugar or sugarless. The same or different bulk sweetener or sweeteners used in the jelly material may be used in the liquid filling. Preferred sugarless bulk sweeteners may be selected from the group consisting of sorbitol, maltitol, xylitol, erythritol, lactitol, hydrogenated starch hydrolysates, hydrogenated isomaltulose, polydextrose, mannitol, and mixtures thereof. Preferred sugar bulk sweeteners may be selected from the group consisting of fructose, glucose, corn syrup solids, sucrose, starch hydrolysates, maltodextrins and mixtures thereof While not preferred, both sugar and sugarless bulk sweeteners may be used together.

The jelly material 12 may be made with between about 9% and about 19% gelling agent. However, if softer products are desired, the gelling agent may be as low as 4% of the jelly material. In some embodiments the gelling agent comprises between about 10% and about 15% gelling agent, and may comprise about 11% of the jelly material. The gelling agent may be selected from the group consisting of gelatin, pectin, agar agar, and mixtures thereof. Less preferably the gelling agent may comprise starch or gum arabic. The preferred gelling agent is gelatin which has a Bloom of between about 150 and about 280. The amount and type of gelling agent that is used will generally make it so that the product maintains its shape at a temperature of 35° C.; more preferably the product maintains its shape at a temperature of 40° C. In some embodiments the jelly material also comprises between about 50% and about 80% bulk sweetener, between about 0.01% and about 4% citric acid, between about 0.01% and about 3% flavor and between about 0.01% and about 0.1% high-intensity sweetener.

The liquid filling may include between about 0.5% and about 5% flavor to provide the product with a strong initial flavor impact when bitten into. In one embodiment the liquid filling includes about 0.5% and about 5% menthol and a level of flavor in addition to the menthol of between about 0.3% and about 3.5%. The liquid filling also comprises between about 0.05% and about 0.3% of a thickening agent. The thickening agent may be selected from the group consisting of xanthan gum, pectin, agar agar, carageenan and mixtures thereof. In one embodiment xanthan gum is used as the thickening agent, and comprises about 0.17% the liquid filling. The liquid filling may comprise between about 1% and about 3% menthol, more preferably about 2% menthol. The liquid filling may further contain between about 0.001% and about 0.5% color, more preferably between about 0.1% and about 0.2% color.

On a dry basis, the liquid filling may include between about 70% and about 90% bulk sweetener, between about 0.05% and about 0.3% xanthan gum, between about 0.01% and about 3% citric acid, between about 0.5% and about 5% menthol, between about 0.3% and about 3.5% flavor in addition to the menthol, between about 0.001% and about 0.5% color and between about 0.01% and about 0.6% high-intensity sweetener. The high-intensity sweetener may be selected from the group consisting of aspartame, acesulfame K, neohespridine, saccharin, thaumatin, and mixtures thereof. The additional flavoring agents may include fruit flavors, particularly black currant flavor.

The flavors that are used in the jelly material and in the liquid filling may include physiological cooling agents, as well as essential oils, synthetic flavors, or mixtures including but not limited to oils derived from plants and fruits such as citrus oils, fruit essences, peppermint oil, spearmint oil, clove oil, oil of wintergreen, anise and the like. Artificial flavoring components are also contemplated for use in the confectionary product. Those skilled in the art will recognize that natural and artificial flavoring agents may be combined in any sensorially acceptable blend. All such flavors and flavor blends are contemplated by the present invention.

One method of making the center-filled jelly product involves making the outer jelly material 12 and the liquid center filling 14 and then depositing them in a mold to make the product 10. A method of depositing the materials is a co-depositing technique, but other methods are also available.

To make the outer jelly confection, the gelling agent is dissolved in water to form a gelling solution. Meanwhile, a syrup containing a bulk sweetener is cooked (heated to drive off moisture) to form a first mass. The gelling solution and the first mass, and optionally one or more secondary ingredients, are mixed to form a second mass. The liquid filling is made by mixing a thickening agent, one or more bulk sweeteners, water and flavor. When both the liquid filling and second mass are ready, they are deposited into a mold.

The mold may be a flexible mold, such as silicon, it may comprise depressions made in a bed of powder material, such as starch, or it may be a coated metal mold that includes an ejector pin to help demold the product. In an embodiment, the second mass and liquid filling are deposited in blisters formed in a sheet of material, and the product is packaged while still in the blisters.

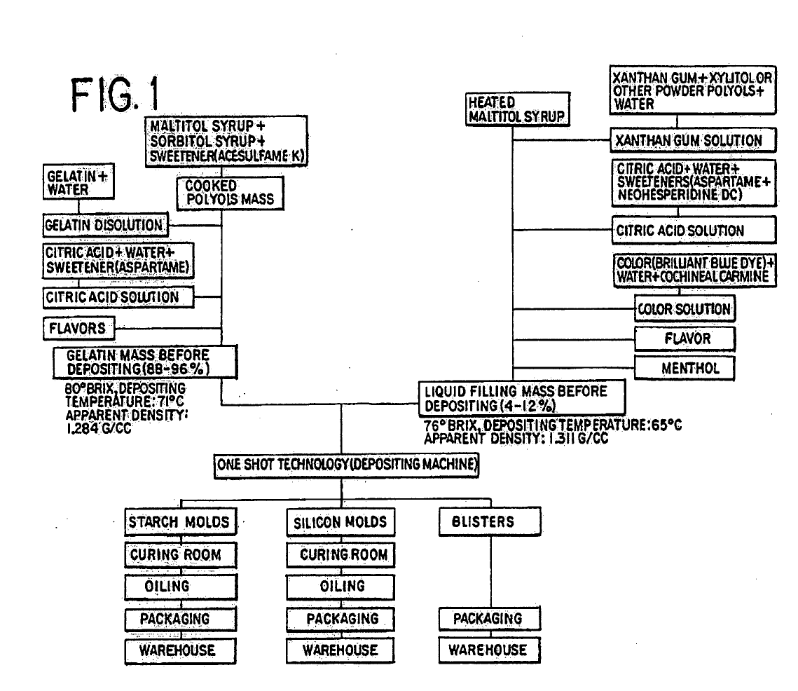

A method of making the product 10 is outlined in FIG. 1. In this embodiment, the first mass is made by heating a solution of maltitol and sorbitol syrups, along with acesulfame K. The first mass may be heated using vacuum cooking. The syrup may be made from a powdered bulk sweetener dissolved in water, or it may be supplied to the process in the form of a syrup directly from the manufacturer. Meanwhile, gelatin is dissolved in water to form a gelatin solution; and citric acid, water and aspartame are mixed to form a citric acid solution. Once the first mass reaches the desired concentration, it is mixed with the gelatin solution, the citric acid solution and flavor to form the second mass.

The liquid filling may be made by cooking (heating to remove moisture) one or more syrups comprising the one or more bulk sweeteners. Thus, the water in the liquid filling may be provided at least in part by providing the bulk sweetener used to make the liquid filling in the form of a syrup, such as a heated maltitol syrup as shown in FIG. 1. The thickening agent, such as xanthan gum, may be mixed with a bulk sweetener and water prior to being mixed into the liquid filling. When the product is sugarless, the bulk sweeteners may include xylitol and other polyols. Also, as shown in FIG. 1, citric acid, water, aspartame and neohesperidine are mixed together to form a citric acid solution. Meanwhile, the color may be mixed to form a color solution. Then the heated syrup, the xanthan gum solution, the citric acid solution, the color solution, flavor and menthol are all mixed together to form the liquid filling.

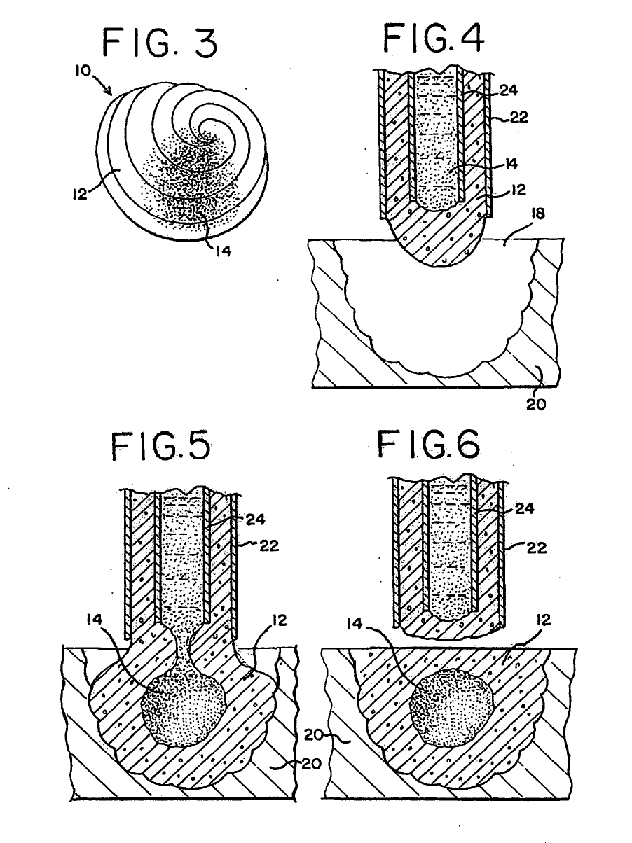

FIGS. 4-6 show an example co-depositing operation into a depression 18 formed in a bed or powdered material 20. The first mass 12 is delivered in a tube 22. Inside of that tube is another tube 24, containing the liquid filling 14. The viscosity of the second mass is such that it stays in the tube 22 until forced out. Once the tube 22 is over the depression 18, the second mass is forced out of the tube to begin to fill the depression. As shown in FIG. 5, after the depression is partly filled, the liquid filling 14 is also forced out of tube 24, forming a liquid center in the partially filled depression. Additional second mass is delivered after the liquid filling has stopped flowing to fill in the top of the mold, and encase the liquid filling 14. Depositing equipment, such as model M3000 or MX3000 from NID, 18 Stokes Ave., Alexandria, Sydney, Australia, or other machinery suppliers such as W&D, Hosokawa and APV Baker, may be used to deposit the confectionery.

Successfully depositing the liquid filling and second mass (referred to in FIG. 1 as a gelatin mass) so that the liquid filling is completely encased in the jelly component requires that several conditions be observed. First, the temperature and Brix of the two components must be controlled so that they are the right consistency for depositing. More importantly, if the liquid filling is co-deposited with the second mass, the densities of the two products must be very close to one another so that the liquid filling neither sinks down nor floats up in the second mass before the second mass cools and becomes solid. In this regard, it is preferable if the liquid filling and second mass have densities that are within 0.05 g/cc of each other, more preferably within 0.02 g/cc of each other. In an embodiment, the liquid filling and second mass each have a density of about 1.3 g/cc.

The second mass may have a Brix of between about 70° and about 85°, more preferably between about 75° and about 78°, when it is deposited. After the product has cured, the Brix of the second mass will often be between about 81 ° and about 85°. The liquid filling may have a Brix of between about 70° and about 85°, more preferably between about 74° and about 78°, when it is deposited. The Brix of one material is independent of the other material. However, the preferred Brix conditions have been found suitable so that “tails” are not formed as the liquid center filling is deposited, which would result in a leak path in the jelly material.

The second mass may be deposited at a temperature of between about 60° C. and about 85° C., and the liquid filling is deposited at a temperature of between about 50° C. and about 85° C. More preferably, the second mass is deposited at a temperature of between about 75° C. and about 80° C., and the liquid filling is deposited at a temperature of between about 70° C. and about 80° C. Most preferably the second mass is deposited at a temperature of about 71° C., and the liquid filling is deposited at a temperature of about 65° C. The second mass may have a water content of between about 12% and about 22%, more preferably between about 17% and about 18%, when it is deposited. The liquid filling may have a water content of between about 15% and about 25%, more preferably between about 19% and about 20%, when it is deposited.

As noted in FIG. 1, the product may be deposited into starch molds. After the deposition, the starch molds are sent to a curing room. During curing the second mass cools and dries to form a product which has a flexible, quite hard and rubbery texture that is difficult to chew. After the product is cured it is demolded and treated to oiling, packaging and warehousing steps that are common for jelly products formed in a starch mold. Alternatively, the product is deposited in a silicon mold, or a coated metal mold After the product is cured, it is demolded and also treated to oiling, packaging and warehousing steps. The product removed from the mold may be packaged in plastic bags, metal boxes or other containers suitable to maintain the product's quality during distribution. In one embodiment, the molds comprise blisters that are formed in a sheet of material. The product is deposited in these blisters, and stays in the blisters while the product is packaged and distributed. The consumer thus removes the product from the blister sheet just before the product is consumed.

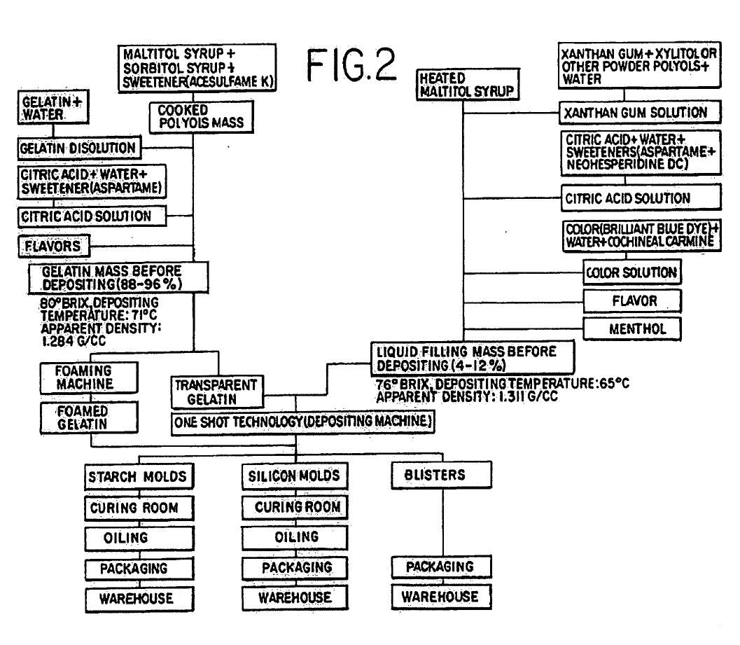

In addition to a method of co-depositing, the second mass may be deposited in a first part, followed by deposition of the liquid filling and a second deposition of the second mass. One embodiment of this is shown in FIG. 2. The processes of FIG. 1 and FIG. 2 are the same until the step of depositing. At this point, the gelatin mass is divided into two steams. One remains transparent and is deposited first into the lower part of the mold. The liquid filling can be co-deposited, or deposited later. However, in this embodiment, the second mass is not used to finish filing the mold. Rather, some of the second mass is fed into a foaming machine where air is mixed in with it before it is deposited to form a foam layer. The foamed gelatin is applied to finish filing the mold. With this embodiment the density of the liquid filling can be less than that of the transparent gelatin because the foamed gelatin will have an even lower density, thus preventing the liquid filling from floating up in the deposited product.

The second mass may comprise between about 80% and about 96% of the product, and the liquid filling may comprise between about 4% and about 20% of the product. More preferably, the liquid filling comprises between about 8% and about 12% of the product. The product may have a piece weight of between about 2 and about 8 grams.

An exemplary product is a packaged center-filled product comprising a) a sheet of material having a plurality of blister cavities formed therein; and b) a filled jelly product in each cavity comprising an outer jelly material having a shape conforming to the blister cavity and completely encasing a liquid center filling. The liquid center comprises about 60% to about 80% maltitol; about 0.05% to about 0.3% xanthan gum; about 0.01% to about 3% citric acid; about 0.01% to about 0.6% high-intensity sweetener; about 0.1% to about 5% menthol; about 0.2% to about 1.5% fruit flavor; about 0.001% to about 0.5% color; and about 19% to about 26% moisture. The outer jelly material comprises about 50% to about 70% maltitol; about 20% to about 40% sorbitol; about 0.01% to about 4% citric acid; about 0.01% to about 0.1% high-intensity sweetener; about 9% to about 19% gelatin; about 0.3% to about 3% fruit flavor; and about 15% to about 23% moisture.

The invention will be better understood by way of the follow example, which is not to be taken as limiting.

### EXAMPLE 1

A liquid center-filled product was made according to the process outlined in FIG. 1. Table 1 gives the composition of the ingredients going into the outer layer. Table 2 gives the ratio of the ingredients going into the outer layer, and takes into account the moisture loss while cooking the first mass and while curing the product. Table 3 gives the composition of the ingredients going into liquid center filling. Table 4 gives the ratio of the ingredients going into the center filling. The maltitol syrup used was Lycasin (® 80/55 from Roquette. The sorbitol syrup was 70/70 sorbitol also from Roquette.

TABLE 1

| | % | grams |
|---|---|---|
| COOKED POLYOLS MASS | | |
| MALTITOL SYRUP | 66.43 | 515.000 |
| SORBITOL 70/70 | 33.54 | 260.000 |
| ACESULFAME K | 0.03 | 0.250 |
| | 100.00 | 775.250 |
| GELATIN SOLUTION | | |
| GELATIN (250 BLOOM) | 37.00 | 111.000 |
| WATER | 63.00 | 189.000 |
| | 100.00 | 300.000 |
| CITRIC ACID SOLUTION | | |
| CITRIC ACID | 50.00 | 10.000 |
| WATER | 50.00 | 10.000 |
| Total | 100.00 | 20.000 |

TABLE 2

| | % | grams |
|---|---|---|
| COOKED POLYOLS MASS | 92.64 | 775.245 |
| cooking water loss | −23.25 | −194.555 |
| Sub-total | 69.39 | 580.690 |
| GELATIN SOLUTION | 35.85 | 300.000 |
| CITRIC ACID SOLUTION | 2.39 | 20.000 |
| ASPARTAME | 0.05 | 0.450 |
| BLACK CURRANT FLAVOR | 1.98 | 16.600 |
| Sub-total | 109.66 | 917.740 |
| curing room water loss | −9.66 | −80.891 |
| Total | 100.00 | 836.849 |

TABLE 3

| | % | grams |
|---|---|---|
| XANTHAN GUM SOLUTION | | |
| WATER | 95.24 | 7.623 |
| XYLITOL | 3.17 | 0.254 |
| XANTHAN GUM | 1.59 | 0.127 |
| | 100.00 | 8.005 |
| CITRIC ACID SOLUTION | | |
| CITRIC ACID | 50.00 | 0.444 |
| WATER | 50.00 | 0.444 |
| | 100.00 | 0.888 |
| BRILLIANT BLUE SOLUTION | | |
| WATER | 95.00 | 0.006913 |
| BRILLIANT BLUE 85% Dye | 5.00 | 0.000364 |
| Total | 100.00 | 0.007277 |

TABLE 4

| LIQUID FILLING | % | grams |
|---|---|---|
| MALTITOL SYRUP 85% DS | 84.60 | 61.567 |
| XANTHAN GUM SOLUTION | 11.00 | 8.005 |
| CITRIC ACID SOLUTION | 1.22 | 0.888 |
| ASPARTAME | 0.20 | 0.146 |
| ACESULFAME K | 0.20 | 0.146 |
| NEOHESPERIDINE DC | 0.02 | 0.011 |
| BRILLIANT BLUE SOLUTION | 0.01 | 0.007 |
| COCHINEAL CARMINE | 0.15 | 0.109 |
| BLACK CURRANT FLAVOR | 0.60 | 0.437 |
| MENTHOL | 2.00 | 1.455 |
| Total | 100.00 | 72.769 |

The jelly material was deposited into a starch mold in a first part, then the liquid filling was added, then a cap of the jelly material was added to finish the piece. The jelly material was deposited at 71° C. and with a Brix of 800 and an apparent density of 1.284 g/cc so that it formed 92% of the product. The liquid filling was deposited at 65° C. and with a Brix of 76° and an apparent density of 1.311 g/cc so that it constituted 8% of the product.

### EXAMPLE 2

### Sugar Jelly

Table 5 shows the ingredients that can be used to make a jelly material for use as the outer layer using sugar bulk sweeteners.

TABLE 5

| | % | grams |
|---|---|---|
| CORN SYRUP 42 DE | 53.35 | 674.91 |
| SUGAR | 30.15 | 381.41 |
| SORBITOL 70/70 | 1.71 | 21.67 |
| AGAR-AGAR | 0.87 | 10.97 |
| Sub-total | 86.08 | 1088.96 |
| ADDED WATER | 0.87 | 11.04 |
| COOKED SUGARS Sub-total | 86.95 | 1100.00 |
| GELATIN SOLUTION IN WATER | 10.28 | 130.00 |
| 1:2 RATIO | | |
| CITRIC ACID SOLUTION IN WATER | 3.16 | 40.00 |
| 1:1 RATIO | | |
| FLAVOR | 0.64 | 8.08 |
| Sub-total | 101.03 | 1278.08 |
| Curing room water loss | −1.03 | −13.10 |
| Total | 100.00 | 1264.98 |

Table 6 shows the ingredients that can be used to make a liquid center filling using sugar bulk sweeteners.

TABLE 6

| LIQUID FILLING | % |
|---|---|
| CORN SYRUP 42-43 DE, 45° BEAUME | 84.80 |
| XANTHAN GUM SOLUTION | 11.00 |
| CITRIC ACID SOLUTION | 1.22 |
| ASPARTAME | 0.10 |
| ACESULFAME K | 0.10 |
| NEOHESPERIDINE DC | 0.02 |
| BRILLIANT BLUE SOLUTION | 0.01 |
| COCHINEAL CARMINE | 0.15 |
| BLACK CURRANT FLAVOR | 0.60 |
| MENTHOL | 2.00 |
| Total | 100.00 |

### EXAMPLE 3

### Sugarfree Jelly

Table 7 shows the ingredients that can be used to make a jelly material for use as the outer layer using sugarless bulk sweeteners.

TABLE 7

| | % | grams |
|---|---|---|
| MALTITOL SYRUP | 97.00 | 1227.43 |
| SORBITOL 70/70 | 1.71 | 21.66 |
| AGAR-AGAR | 0.87 | 10.97 |
| ACESULFAME K | 0.03 | 0.42 |
| Sub-total | 99.61 | 1260.48 |
| COOKING WATER LOSS | −12.68 | −160.48 |
| COOKED SUGARS Sub-total | 86.93 | 1100.00 |
| GELATIN SOLUTION IN WATER | 10.27 | 130.00 |
| 1:2 RATIO | | |
| CITRIC ACID SOLUTION IN WATER | 3.16 | 40.00 |
| 1:1 RATIO | | |
| FLAVOR | 0.64 | 8.08 |
| ASPARTAME | 0.03 | 0.40 |
| Sub-total | 101.03 | 1278.48 |
| Curing room water loss | −1.03 | −13.03 |
| Total | 100.00 | 1265.45 |

The liquid filling in the product is released when the product is bitten into. The high level of flavor and menthol in the liquid center gives a very strong flavor and menthol “kick” to the product. At the same time, the external material is chewy and stays in the mouth for a while. There is a duration of flavor as the product is masticated.

One of the reasons that xanthan gum is preferred is because it has been found that when gelatin is used for the gelling agent in the outer jelly material, and xanthan gum is used for the thickening agent in the liquid center filling, the center liquid filling and chewy outer layer do not mix with one another while the product is in a liquid state, nor does the liquid center dissolve the jelly material, forming a cloudy appearance. Rather, the boundary between the liquid center and the jelly material maintains a distinct form. The center filling, being colored, can then readily be seen in the transparent jelly material.

Neohesperidine is a preferred high-intensity sweetener because it has been found to reduce the bitter effect of high levels of menthol in the center filling. While it is preferred to heat the syrup used to make the liquid filling and reduce its moisture content, it may be possible to use 85% solids maltitol solutions directly from a manufacturer.

If the product is deposited into starch, it will loose more moisture during the curing step than if it is deposited into flexible silicon molds or blisters in a tray. Thus the final moisture content of the outer jelly material will be about 17% to about 23%, more preferably about 20%, in a blister, but more like 15% to about 21% if molded in a starch mold.

It should be appreciated that the methods and compositions of the present invention are capable of being incorporated in the form of a variety of embodiments, only a few of which have been illustrated and described above. The invention may be embodied in other forms without departing from its spirit or essential characteristics. For example, the liquid filling need not be disposed in the center of the product. The outer jelly material just needs to encase it with a wall thickness sufficient that the liquid does not leak out. While the preferred jelly material is clear and uncolored, it could be transparent and slightly tinted. If the product is deposited with a first deposition of the outer jelly material and then the liquid filling, with a second depositing step for the remainder of the jelly material, the jelly material deposited in the last step may be colored, giving a product with multi colors. Also, the flavor in the liquid filling may be designed to be one more appealing to youngsters, and have a strong fruit flavor and even a sour kick instead of a menthol kick.

It will be appreciated that the addition of some other ingredients, process steps, materials or components not specifically included will have an adverse impact on the present invention. The best mode of the invention may therefore exclude ingredients, process steps, materials or components other than those listed above for inclusion or use in the invention. However, the described embodiments are to be considered in all respects only as illustrative and not restrictive, and the scope of the invention is, therefore, indicated by the appended claims rather than by the foregoing description. All changes which come within the meaning and range of equivalency of the claims are to be embraced within their scope.

We claim:

1. A method of making a center-filled jelly product comprising:
a) making an outer jelly confection by:
i) dissolving a gelling agent in water to form a gelling solution;
ii) heating a syrup containing a bulk sweetener to remove moisture and thereby form a first mass; and
iii) mixing the first mass, the gelling solution and optionally one or more secondary ingredients to form a second mass;
b) making a liquid filling by mixing a thickening agent, one or more bulk sweeteners, water and flavor to form a liquid filling; and
c) depositing the second mass at a temperature of between about 60° C. and about 85° C., and the liquid filling at a temperature of between about 50° C. and about 85° C., into a mold such that the liquid filling is totally encased by the second mass and the second mass will fill into at least a portion of the shape of the mold.

2. The method of claim 1 wherein the liquid filling is made by heating one or more syrups comprising the one or more bulk sweeteners.

3. The method of claim 1 wherein the second mass is deposited at a temperature of between about 75° C. and about 80° C., and the liquid filling is deposited at a temperature of between about 70° C. and about 80° C.

4. The method of claim 1 wherein said thickening agent is selected from the group consisting of xanthan gum, pectin, agar agar, carageenan and mixtures thereof.

5. The method of claim 1 wherein said water in the liquid filling is provided at least in part by providing the bulk sweetener used to make the liquid filling in the form of a syrup.

6. The method of claim 1 wherein said flavor in the liquid filling comprises menthol and additional flavoring agents.

7. The method of claim 1 wherein said bulk sweetener in the first mass comprises a sugarless bulk sweetener selected from the group consisting of sorbitol, maltitol, xylitol, erythritol, lactitol, hydrogenated starch hydrolysates, polydextrose, hydrogenated isomaltulose, mannitol, and mixtures thereof.

8. The method of claim 1 wherein said bulk sweetener in said first mass comprises a sugar selected from the group consisting of fructose, glucose, corn syrup solids, sucrose, starch hydrolysates, maltodextrins and mixtures thereof.

9. The method of claim 1 wherein said secondary ingredients comprise one or more of a food grade acid, flavor and high-intensity sweetener.

10. The method of claim 1 wherein said liquid filling has a water content of between about 15% and about 25% when it is deposited.

11. The method of claim 1 wherein said second mass has a water content of between about 12% and about 22% when it is deposited.

12. The method of claim 1 wherein said second mass has a Brix of between about 700 and about 85° when it is deposited.

13. The method of claim 1 wherein said second mass has a Brix of between about 75° and about 78° when it is deposited.

14. The method of claim 1 wherein said liquid filling has a Brix of between about 70° and about 85° when it is deposited.

15. The method of claim 1 wherein said liquid filling has a Brix of between about 74° and about 78° when it is deposited.

16. The method of claim 1 wherein said liquid filling further comprises between about 0.001% and about 0.5% color.

17. The method of claim 1 wherein said second mass and liquid filling are deposited in a flexible mold.

18. The method of claim 1 wherein said second mass and liquid filling are deposited into depressions made in a bed of powder material.

19. The method of claim 1 wherein said second mass and liquid filling are deposited into blisters and the product is packaged while still in said blisters.

20. The method of claim 1 wherein said second mass and liquid filling are deposited into metal molds.

21. The method of claim 1 wherein the liquid filling is deposited while the second mass is being deposited.

22. The method of claim 1 wherein the second mass is deposited in a first part, followed by deposition of the liquid filling and a second deposition of the second mass.

23. The method of claim 22 wherein the second mass used in the second deposition has air mixed in with it before it is deposited to form a foam layer.

24. The method of claim 1 wherein said second mass comprises between about 80% and about 96% of the product, and the liquid filling comprises between about 4% and about 20% of the product.

25. The method of claim 1 wherein said second mass comprises between about 88% and about 92% of the product and the liquid filling comprises between about 8% and about 12% of the product.

26. The method of claim 1 wherein said gelling agent is selected from the group consisting of gelatin, pectin, agar agar, and mixtures thereof.

27. The method of claim 1 wherein said gelling agent comprises between about 4% and about 19% of the outer jelly confection.

28. The method of claim 1 wherein said second mass comprises between about 50% and about 80% bulk sweetener, between about 9% and about 19% gelatin, between about 0.01% and about 4% citric acid, between about 0.01% and about 3% flavor and between about 0.01% and about 0.1% high-intensity sweetener.

29. The method of claim 1 wherein said second mass cools and dries to form a product which has a flexible, quite hard and rubbery texture that is difficult to chew.

30. The method of claim 1 wherein said second mass is transparent and the liquid filling is colored.

31. The method of claim 1 wherein the thickening agent is mixed with a bulk sweetener and water prior to being mixed into the liquid filling.

32. The method of claim 1 wherein the liquid filling and second mass have densities that are within 0.05 g/cc of each other.

33. The method of claim 1 wherein the liquid filling and second mass each have a density of about 1.3 g/cc.

34. The method of claim 1 wherein the first mass is heated using vacuum cooking.

35. A center-filled jelly product comprising:
a) a liquid filling containing between about 0.5% and about 5% menthol and a level of flavor in addition to the menthol of between about 0.3% and about 3.5% to provide the product with a strong initial flavor impact when bitten into; and
b) jelly material completely encasing the liquid filling, the jelly material comprising between about 9% and about 19% gelling agent and providing a chewy texture to the product.

36. The product of claim 35 comprising a bitterness reducer in the liquid filling.

37. The product of claim 35 wherein the jelly material is transparent and uncolored, and the liquid filling is colored and visible through the jelly material.

38. The product of claim 35 wherein said gelling agent comprises between about 10% and about 15% of the jelly material.

39. The product of claim 35 wherein said liquid filling comprises between about 0.05% and about 0.3% of a thickening agent.

40. The product of claim 39 wherein said liquid filling comprises about 0.17% xanthan gum as said thickening agent.

41. The product of claim 35 wherein the liquid filling and encasing jelly material have a distinct boundary between them.

42. The product of claim 35 wherein said liquid center comprises between about 1% and about 3% menthol.

43. The product of claim 35 wherein said liquid filling comprises (on a dry basis) between about 70% and about 90% bulk sweetener, between about 0.05% and about 0.3% xanthan gum, between about 0.01% and about 3% citric acid, between about 0.5% and about 5% menthol, between about 0.3% and about 3.5% flavor in addition to the menthol, between about 0.001% and about 0.5% color and between about 0.01% and about 0.6% high-intensity sweetener.

44. The product of claim 35 wherein the product maintains its shape at a temperature of 35° C.

45. The product of claim 35 wherein the product maintains its shape at a temperature of 40° C.

46. The product of claim 35 wherein the product is sugarless.

47. The product of claim 35 wherein the jelling agent comprises gelatin with a Bloom of between about 150 and about 280.

48. The product of claim 35 wherein the product further comprises a high-intensity sweetener selected from the group consisting of aspartame, acesulfame K, neohespridine, saccharin, thaumatin, and mixtures thereof.

49. A packaged center-filled product comprising:
a) a sheet of material having a plurality of blister cavities formed therein; and
b) a filled jelly product in each cavity comprising an outer jelly material having a shape conforming to the blister cavity and completely encasing a liquid center filling; the liquid center comprising:
i) about 60% to about 80% maltitol;
ii) about 0.05% to about 0.3% xanthan gum;
iii) about 0.01% to about 3% citric acid;
iv) about 0.01% to about 0.6% high-intensity sweetener;
v) about 0.1% to about 5% menthol;
vi) about 0.2% to about 1.5% fruit flavor;
vii) about 0.001% to about 0.5% color; and
viii) about 19% to about 26% moisture;
and the outer jelly material comprising:
i) about 50% to about 70% maltitol;
ii) about 20% to about 40% sorbitol;
iii) about 0.01% to about 4% citric acid;
iv) about 0.01% to about 0.1% high-intensity sweetener;
v) about 9% to about 19% gelatin;
vi) about 0.3% to about 3% fruit flavor; and
vii) about 15% to about 23% moisture.

50. A center-filled jelly product comprising:
a) a liquid filling containing between about 0.5% and about 5% flavor to provide the product with a strong initial flavor impact when bitten into and about 0.05% and about 0.3% xanthan gum as a thickening agent; and
b) jelly material completely encasing the liquid filling, the jelly material comprising between about 9% and about 19% gelatin and providing a chewy texture to the product.

51. A center-filled jelly product comprising:
a) a liquid filling containing between about 0.5% and about 5% flavor to provide the product with a strong initial flavor impact when bitten into and a coloring; and
b) jelly material completely encasing the liquid filling, the jelly material being transparent and comprising between about 9% and about 19% gelling agent and providing a chewy texture to the product.
